(19) United States
(12) Patent Application Publication
(10) Pub. No.: US 2002/0149537 A1
(43) Pub. Date: Oct. 17, 2002

(54) Antenna and radio device comprising the same

(76) Inventors: Masahiro Ohara, Osaka (JP); Toyoshi Fukumura, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/048,062

(22) PCT Filed: Jun. 8, 2001
(86) PCT No.: PCT/JP01/04868

(30) Foreign Application Priority Data
Jun. 9, 2000 (JP) 2000-173136

(51) Int. Cl. H01Q 1/36

(52) U.S. Cl. 343/895

(57) ABSTRACT

An antenna capable of transmitting/receiving waves in multi-ranged frequency bands providing high antenna gain, reliability and productivity, and a radio communication apparatus using the same. The feed portion is electrically connected with the antenna element portion at its one end, and with the radio-frequency circuit of the apparatus at the other end. The dielectric material-made core rod mechanically supports the antenna element portion. The dielectric material-made radome partially covers the antenna element and feed portions. The antenna element portion is formed of an approximately helical-shaped portion and an approximately meander-shaped portion, both of which are made of a thin-belt-shaped conductive plate and concentrically formed on the core rod. Properly adjusting of the helical-shaped and the meander-shaped portions can provide impedance characteristics optimal for multi-ranged frequency bands.

### FIELD OF THE INVENTION

The present invention relates to an antenna fixed to a radio communication apparatus for mobile communications and a radio communication apparatus using the same.

### BACKGROUND OF THE INVENTION

In recent years, as a demand for mobile communications drastically increases, radio communication apparatuses have been developed in a wide variety of forms. An example of the diversity is a radio communication apparatus capable of transmitting/receiving radio waves in multi-ranged frequency bands so that a single radio communication apparatus can handle as much information as possible. Such an apparatus includes an antenna having desirable impedance characteristics over multi-ranged frequency bands.

A mobile phone system is the typical example of the mobile communications, which is now widely used all over the world. The frequency bandwidth for the mobile phone system varies by region: for the frequency bandwidth for digital mobile telephone system, Personal Digital Cellular 800 (PDC 800) in Japan uses the frequency in the range from 810 to 960 MHz. On the other hand, in the West, the range from 890 to 960 MHz is for Group Special Mobile Community (GSM), the range from 1,710 to 1,880 MHz for Personal Communication Network (PCN), and the range from 1,850 to 1,990 MHz for Personal Communication System (PCS). Generally, for the mobile phone corresponding to each of the multi-ranged frequency bands, a helical antenna element formed of helically wound conductive wire is widely used.

FIG. 12 is a general sectional view of the prior-art antenna for two frequency bands—for the range from 890 to 960 MHz of GSM and for the range from 1,710 to 1,880 MHz of PCN. FIGS. 13 and 14 are the graphs that represent the frequency characteristics of voltage standing wave ratio (VSWR) showing impedance characteristics.

In antenna 8 shown in FIG. 12, phosphor bronze wire-made antenna element 3 contains linear portion 1 at the inside of helical portion 2, with each top end of linear portion 1 and helical portion 2 connected into one piece. Feed metal fitting 6 contains, at its top, recess portion 4 to which antenna element 3 is fixed, and at its bottom, mounting screw portion 5 with which fitting 6 is screwed into a radio communication apparatus. Dielectric resin material-made radome 7 partially covers antenna element 3 and feed metal fitting 6. Fitting 6 is attached to the housing of a mobile phone to establish electric connections with the radio-frequency circuitry of the mobile phone, so that antenna 8 can work for two frequency bands mentioned above.

In antenna 8 having the structure above, the electrical length totally gained from linear portion 1 and helical portion 2 of antenna element 3 is adjusted to about λ/2 in the frequency band for PCN, whereas it is adjusted to about λ/4 in the frequency band for GSM. Thus, the electrical coupling between linear portion 1 and helical portion 2 of antenna element 3 allows the impedance characteristics of antenna element 3 to be optimum in each frequency band.

In prior-art antenna 8, the impedance characteristics of antenna element 3 in which the VSWR is to be 3 or less in each frequency band are required. However, it has been difficult for the conventional structure—the one helically wound from one end of a straightened phosphor bronze wire—to satisfy the requirement. Suppose that the electrical length of antenna element 3 is adjusted to about λ/2 in the frequency band for PCN. As shown in FIG. 13, in the frequency band for PCN—between ▴3 and ▴4—the impedance characteristics with the VSWR kept below 3 can be realized with the help of the electrical coupling between liner portion 1 and helical portion 2. On the other hand, in the frequency band for GSM—between ▴1 and ▴2—the range with the VSWR maintained below 3 becomes narrower. Now, to eliminate this inconvenience, suppose that the frequency band for GSM (between ▴1 and ▴2) is broadened by changing the diameter or pitch of helical portion 2 and readjusting the electrical length. This adjustment is no good for the PCN band—it changes the electrical length of antenna element 3 for the frequency band for PCN and the electrical coupling between linear portion 1 and helical portion 2, so that the VSWR in the frequency band for PCN (between ▴3 and ▴4) will be undesirably increased to be more than 4. Thus, there has been a problem in the structure of the prior-art antenna: transmitting/receiving in either one of the frequency bands has been sacrificed for the other.

As another demerit, deformation or variations in diameter or pitch of helical portion 2 occurred during the manufacturing process of antenna element 3 can cause variations in the impedance characteristics. For the variations, it has been difficult to get desired impedance characteristics. Providing complicate impedance-matching circuit between the antenna and the radio-frequency circuitry may be a measure for suppressing the degradation of the impedance characteristics due to the variations. However, this is apparently an obstacle to the lower prices of mobile phones.

### SUMMARY OF THE INVENTION

The present invention addresses the problems above. It is therefore an object of the present invention to provide a reliable antenna with high productivity, which is capable of: having an easy adjustment of the electrical length of the antenna element; obtaining good impedance characteristics in desired multi-ranged frequency bands by a single antenna element; eliminating impedance matching circuitry to minimize variations in the impedance characteristics. At the same time, it is another object of the present invention to realize a cost-reduced radio communication apparatus using the antenna.

To approach aforementioned objects, the antenna of the present invention includes: an antenna element portion transmitting/receiving waves in multi-ranged frequency bands; a feed portion establishing electrical connections between the antenna element portion and a radio-frequency circuit of a radio communication apparatus; a dielectric material-made core rod mechanically supporting the antenna element portion; and a dielectric material-made radome partially covering the antenna element portion and the feed portion. The antenna element portion contains an approximately helical-shaped portion and an approximately meander-shaped portion that are formed concentrically with the core rod.

The antenna of the present invention may be variously embodied as follows.

1) The dielectric material forming the core rod is given a relative dielectric constant different from that forming the radome.

2) A half-round and thin-belt-shaped first conductor has the diameter generally the same as that of the core rod. A plurality of the first conductors are disposed in parallel from a position close to an end of the core rod in its axial direction, at predetermined spaced intervals, on the front-round and the rear-round of the core rod. The rows of the conductors are placed in a staggered arrangement between the front-round surface and the rear-round surface of the rod. A short and thin-belt-shaped conductive plate joins adjacent ends of the first conductors, forming approximately helical-shaped portion. A plurality of thin belt-shaped second conductors are placed in parallel on the core rod. As in the case of the first conductor, a short and thin-belt-shaped conductive plate joins adjacent ends of the second conductors, forming approximately meander-shaped portion. The meander-shaped portion is disposed close to the approximately helical-shaped portion.

3) The antenna element portion may be formed of a die cutting-processed thin and conductive metal-plate.

4) The antenna element portion may be formed of a press-processed conductive metal-wire made of alloys of copper, or other metals provided with an electrolytic plating process.

5) The antenna element portion may be formed of providing a thin conductive plate with an etching process to form a predetermined pattern then press-processing the pattern.

6) The antenna element portion may be formed of a press-processed flexible wiring board with a predetermined pattern formed thereon.

7) The antenna element portion may be formed of printing conductive paste.

8) The antenna element portion may be formed of sintered conductive powder.

9) One end of the approximately helical-shaped portion is joined with one end of the approximately meander-shaped portion so that the helical-shaped portion and the meander-shaped portion are disposed on the rod as a cascaded structure.

10) A position close to the tip of the core rod may have a connecting point, at which one end of the approximately helical-shaped portion and the approximately meander-shaped portion are connected, at which the two portions seem to be “folded over”. The meander-shaped portion is placed on the rod so as to be parallel to the axis of the helical-shaped portion.

11) A position close to the tip of the core rod may have a connecting point, at which one end of the approximately helical-shaped portion and the approximately meander-shaped portion are connected, and at which the two portions seem to be “folded over”. At least a part of each second conductor of the meander-shaped portion is circular arc-shaped, having the diameter almost the same as that of the helical-shaped portion. At the same time, the arrangement of the meander-shaped portion is kept concentrically to the helical-shaped portion, but having no contact with it.

12) The feed portion may be formed with the antenna element portion in one piece.

13) A dielectric material-made radome, which partially covers the antenna element portion and the feed portion, may be removed.

According to the present invention, each electrical length and its ratio of the helical-shaped portion and the meander-shaped portion can be defined easily. As compared with the conventional one, the structure of the present invention can provide desired multi-ranged frequency bands with optimal impedance characteristics with facility. This allows the antenna to be compact and cost-reduced, having the advantages of wide frequency range, high antenna gain, and high reliability.

The present invention covers not only a radio communication apparatus equipped with the antenna, but also a radio communication apparatus equipped with two antennas for diversity communications.

### BRIEF DESCRIPTION OF THE DRAWINGS

FIG. 1 is a perspective view, taken partly in cross-section, of the antenna in accordance with a first preferred embodiment of the present invention.

FIG. 2 is a front view of the antenna in accordance with the first preferred embodiment.

FIG. 3 is a cross-sectional view seen from the front of the antenna in accordance with the first preferred embodiment.

FIG. 4 is a cross-sectional view seen from the right hand side of the antenna in accordance with the first preferred embodiment.

FIG. 5 is a top view of the antenna element of the antenna in accordance with the first preferred embodiment.

FIG. 6 is a graph indicating frequency characteristics of voltage standing wave ratio (VSWR) for the antenna in accordance with the first preferred embodiment.

FIG. 7 is a cross-sectional view seen from the front of the antenna in accordance with a second preferred embodiment.

FIG. 8 is a cross-sectional view seen from the right hand side of the antenna in accordance with the second preferred embodiment.

FIG. 9 is a circuit diagram of a radio communication apparatus equipped with the antenna in a third preferred embodiment.

FIG. 10 is a circuit diagram of a radio communication apparatus equipped with the antenna in a fourth preferred embodiment.

FIG. 11 is a circuit diagram of a radio communication apparatus equipped with the antenna in a fifth preferred embodiment.

FIG. 12 is a cross-sectional view indicating the essential part of the prior-art antenna.

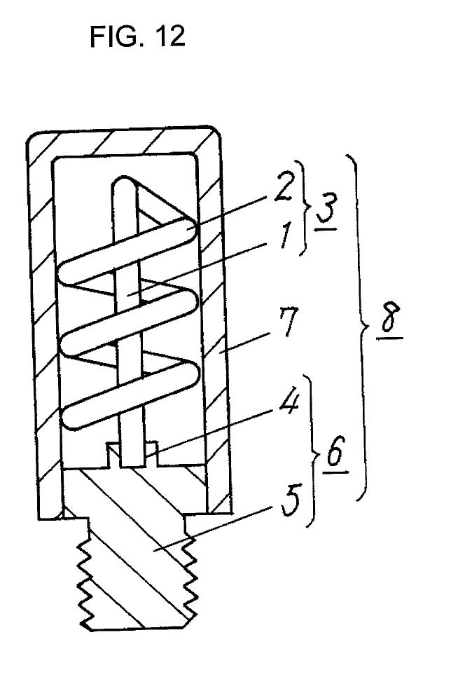

FIG. 13 shows an example of the graph indicating frequency characteristics of VSWR for the prior-art antenna.

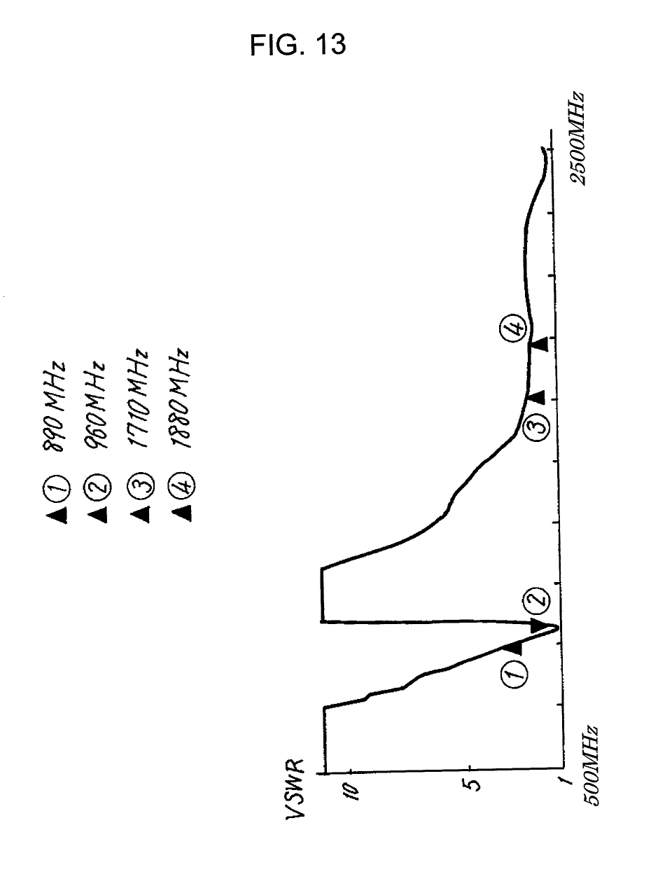

FIG. 14 shows another example of the graph indicating frequency characteristics of VSWR for the prior-art antenna.

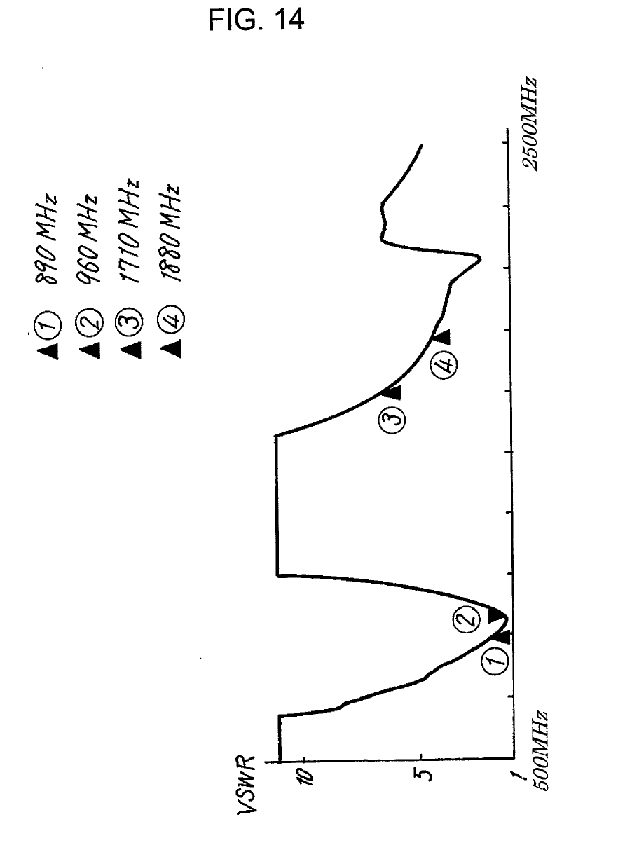

### DESCRIPTION OF THE PREFERRED EMBODIMENTS

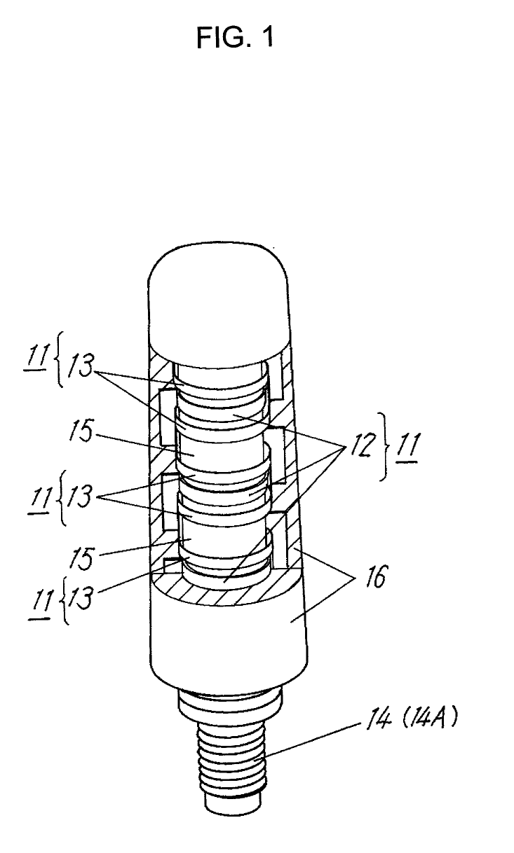

The preferred embodiments of the present invention are described hereinafter with reference to the accompanying drawings, FIG. 1 through FIG. 11.

First Preferred Embodiment

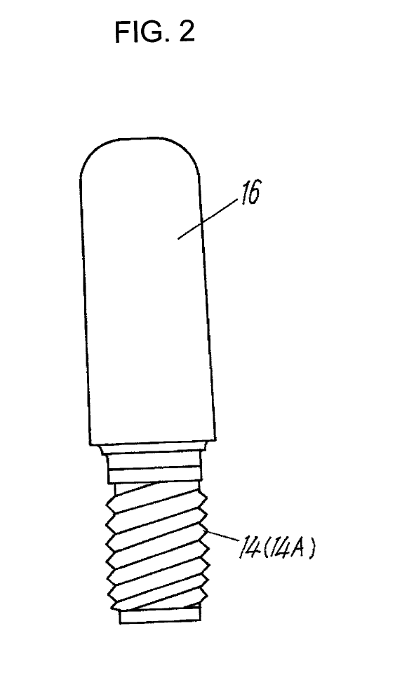

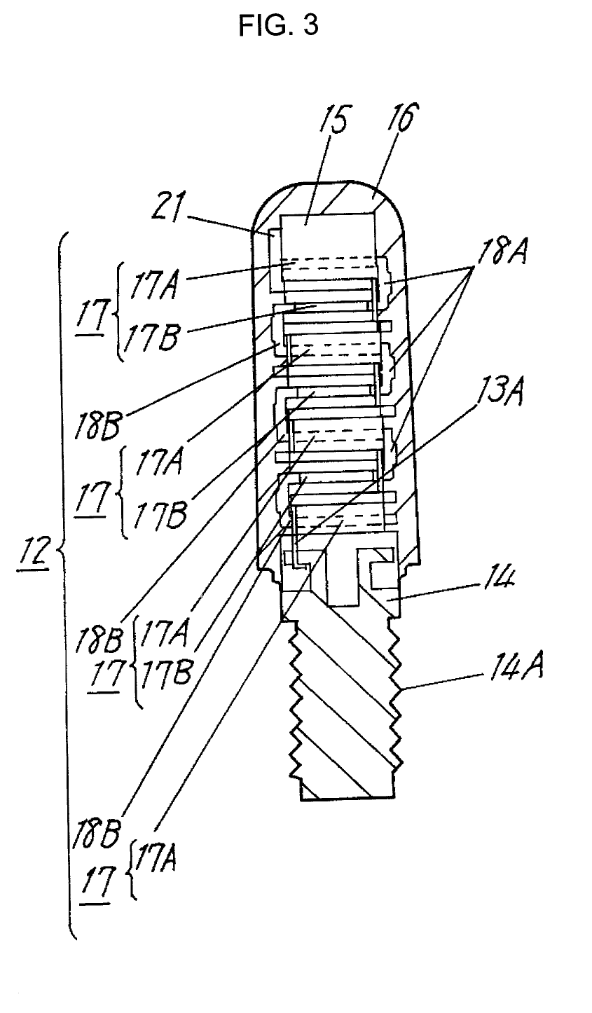

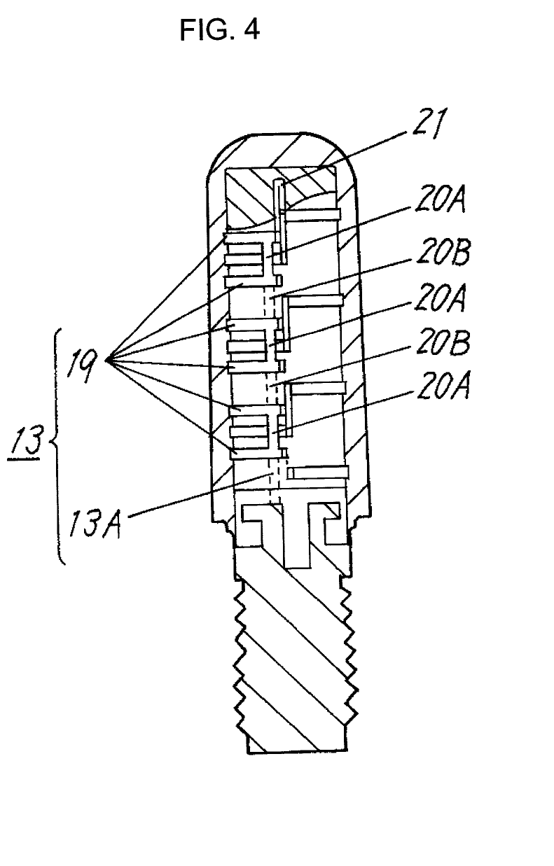

FIG. 1 is a perspective view, taken partly in cross-section, of the antenna in accordance with the first preferred embodiment of the present invention. FIG. 2 shows the appearance of the antenna. FIGS. 3 and 4 show cross-sectional views seen from the front side and from the right-hand side of the antenna, respectively. Antenna element 11 shown in FIG. 1 is formed through the procedures below.

Approximately helical-shaped portion 12 is made of a die cutting- and press-processed thin metal plate with superior conductivity, such as a copper alloy plate. Similarly, approximately meander-shaped portion 13 is also made of a die cutting- and press-processed thin metal plate with superior conductivity, such as a copper alloy plate. Helical-shaped portion 12 and meander-shaped portion 13 are connected with each other at each top end, forming antenna element 11. Both portions 12 and 13 just look like being folded over at the connecting point. Feed metal fitting 14 is connected to bottom end 13A (see FIG. 3) of meander-shaped portion 13 of antenna element 11. Fitting 14 has, on its periphery, mounting screw portion 14A (see FIG. 2) that is to be screwed in a radio communication apparatus using the antenna.

In FIGS. 1 and 2, core rod 15 is made of olefin elastomer resin having a dielectric constant of about 2.2. Rod 15 holds helical-shaped portion 12 and meander-shaped portion 13 of antenna element 11 so as to be concentric to the axis of the rod, providing a non-contacting state between both portions. Rod 15 also keeps an intimate contact with fitting 14. Radome 16 is made of olefin elastomer resin having a dielectric constant of about 2.5. Radome 16 shields the periphery of antenna element 11, with a portion adjacent to mounting screw section 14A of fitting 14 being exposed.

The shape of antenna element 11 is shown in detail in FIGS. 3 and 4. Half-round and thin-belt-shaped first conductor 17 has the diameter generally the same as that of the core rod. A plurality of first conductors 17 are disposed in parallel from the position close to the tip of rod 15 in its axial direction, at predetermined spaced intervals, on front-round 17B and rear-round 17A of the core rod. The rows of conductors 17 are placed on core rod 15 so as to form a staggered arrangement between the front-round and the rear-round of the rod. Short and thin-belt-shaped conductors 18A and 18B join adjacent ends of the first conductors, forming approximately helical-shaped portion 12. Similarly, a plurality of thin belt-shaped second conductors 19 are placed in parallel on one half-round 19 of core rod 15, from the position adjacent to the tip of the rod in its axial direction, at predetermined spaced intervals. As in the case of the joint for the first conductor, short and thin-belt-shaped conductors 20A and 20B join adjacent ends of the second conductors, forming approximately meander-shaped portion 13. As shown in Fig., one end of helical-shaped portion 12 is in an open circuited state, the other is connected with one end of meander-shaped portion 13 at joint 21 adjacent to the tip of core rod 15. Feed metal fitting 14 is connected, as shown in FIG. 3, to other end 13A of portion 13.

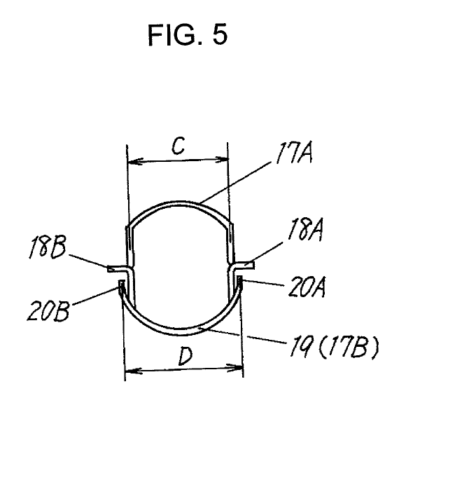

In FIG. 4, each of joint portions 18A, 18B, and 20A, 20B is properly located so that second conductor 19 of meander-shaped portion 13 is retained between each first conductor 17B (indicated by solid lines in FIG. 3), remaining a non-contacting state. In this way, helical-shaped portion 12 and meander-shaped portion 13 are formed. As in this case, when antenna element 11 is formed from the combination of helical-shaped portion 12 and meander-shaped portion 13, joint portions 20A and 20B have no contact with first conductor 17B. To realize this, as shown in the top view of the antenna element in FIG. 5, diameter C is sized a bit smaller than diameter D of second conductor 19 shaped in generally half-round. In addition, joint portions 20A, 20B are slightly spaced from joint portions 18A, 18B, respectively.

The antenna of the embodiment is thus configured. Now will be described how the antenna works.

The antenna shown in FIG. 1 is screwed into a predetermined position of a radio communication apparatus (not shown) by screw portion 14A formed around feed metal fitting 14. Radio-frequency signals corresponding to the waves transmitted/received through the antenna are communicated, via the fitting 14, between the radio-frequency circuit (not shown) of the apparatus and the antenna. The electrical length of antenna element 11 is determined, through the electrical coupling, at an optimal value having good VSWR characteristics in first and second frequency bands.

The electrical length is defined by many factors—an inductance of helical-shaped portion 12 and meander-shaped portion 13, a stray capacitance between a plurality of the first conductors, the stray capacitance between a plurality of the second conductors, a stray capacitance between a plurality of the first conductors and a plurality of the second conductors, and a dielectric constant of core rod 15; and a dielectric constant of radome 16. The electrical length is determined to about 3λ/8 through 5λ/8 , which allows the antenna to have good impedance characteristics in the first frequency band. Similarly, the electrical length is determined to about λ/2 to provide the antenna with a good impedance characteristics in the second frequency band. The two settings of the electrical length allow the antenna element 11 to effectively transmit/receive waves in the two frequency ranges. The reason why single antenna element 11 can handle waves in the two frequency ranges will be described below.

Like the antenna element of the embodiment, the prior-art antenna element can change the diameter or the pitch of the helical portion. In the prior-art, however, the portion corresponding to meander-shaped portion 13 of the embodiment can be changed only in its length and thickness due to the shape of a linear conductor. On the other hand, according to the embodiment, various parameters—the length, the width, the number, and the pitch of the second conductor of meander-shaped portion 13—can be changed. As a result, each stray capacitance and inductance mentioned above can be varied with more flexibility. Therefore, it becomes possible to obtain the electrical length appropriate for two frequency bands by changing these parameters.

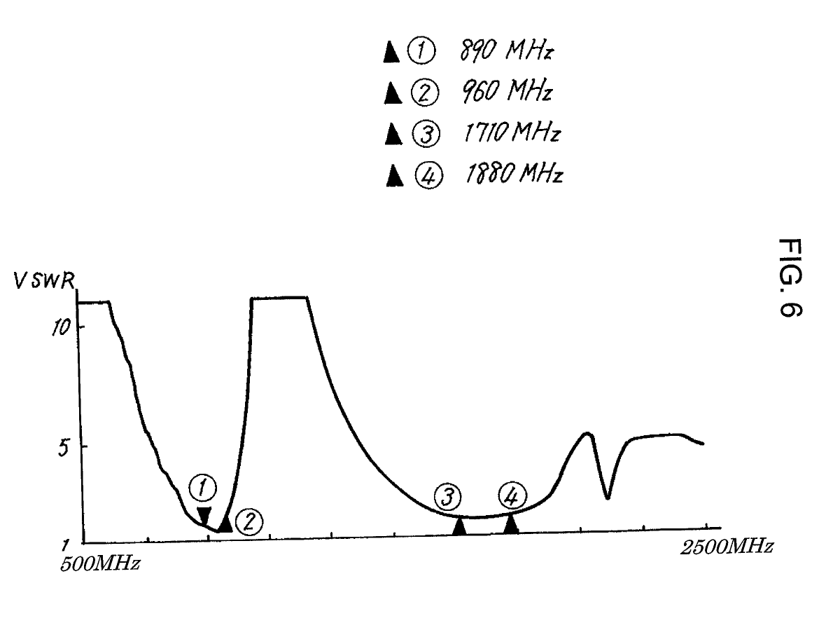

As described above, according to the embodiment, the electrical length is varied, with the help of electrical coupling, by changing the pitch or the diameter of second conductor 19 so that the antenna works with optimal impedance characteristics in the second frequency band. Furthermore, changing the pitch or the diameter of first conductor 17 provides another electrical length by which the antenna works with a good impedance characteristics in the first frequency band, with the impedance characteristics in the second frequency band. Thus the electrical length can be separately determined with no interference between each frequency band and the respective VSWR characteristic. As a result, desired impedance characteristics can be obtained, as shown in FIG. 6—the graph that indicates frequency characteristics of the VSWR for the antenna, in the frequency band not only for GSM ranging from 890 to 960 MHz (between ▴1 and ▴2), but also for PCN ranging 1,710 to 1,880 MHz (between ▴3 and ▴4). This therefore realizes an antenna having wide frequency range and high antenna gain.

In addition, the electrical length can be effectively extended by utilizing the stray capacitance between a plurality of first conductors, the stray capacitance between a plurality of second conductors, the stray capacitance between a plurality of first conductors and a plurality of second conductors, the dielectric constants of the core rod and the radome. An electrical length can be actually obtained by the antenna element mechanically shorter in length than that usually required for the electrical length. This fact contributes to realize a compact and lightweight antenna with higher reliability.

Furthermore, according to the embodiment, antenna element 11 is made of a thin metal plate with superior conductivity through die-cutting and press processes. Such formation minimizes non-uniformity and deformation in the pitch in first conductors 17 and second conductors 19, realizing simple assembly with low cost.

Good impedance characteristics in desired frequency bands may be effectively obtained: by cutting a portion of first conductors 17 or an intentionally disposed adjusting extension of the conductor, by properly defining the number of the conductors of second conductor 19, and by changing the dielectric constant of dielectric materials forming core rod 15 or radome 16. The strength of electrical coupling between helical-shaped portion 12 and meander-shaped portion 13 can be changed by having second conductor 19 with a predetermined slant with respect to first conductor 17B on the front half-round side of core rod 15. This allows the impedance characteristics to be easily and widely controlled. Joint portions 18A, 18B, 20A, and 20B are not necessarily shaped the same as ones shown in FIGS. 3 and 4—for example, V-shaped sharp joint portions can provide as good result as the structure described above. Antenna element 11 of the embodiment is made of a thin metal plate with superior conductivity through die-cutting and press processes. Other than that, the antenna element can be formed of a metal with superior conductivity through mechanical-, electrochemical-, or pressurized and heated forming/processing for the similar effect mentioned above: it could be formed of a metal wire with superior conductivity, such as a copper alloy or a Cu-, Ni-plated metal; an etching-processed conductor; a press-processed flexible wiring board; printed conductive paste or sintered conductive powder.

Second Preferred Embodiment

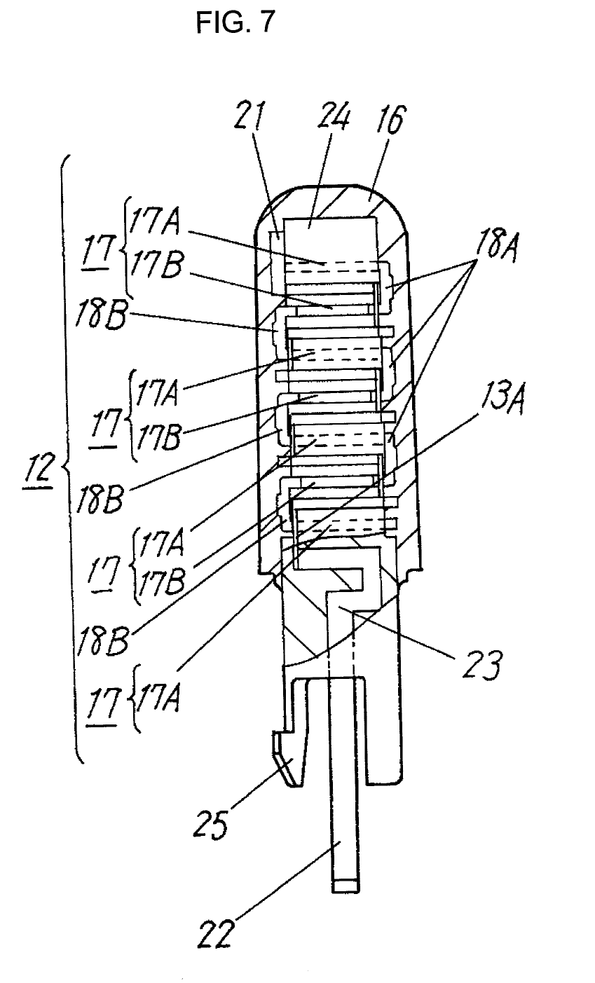

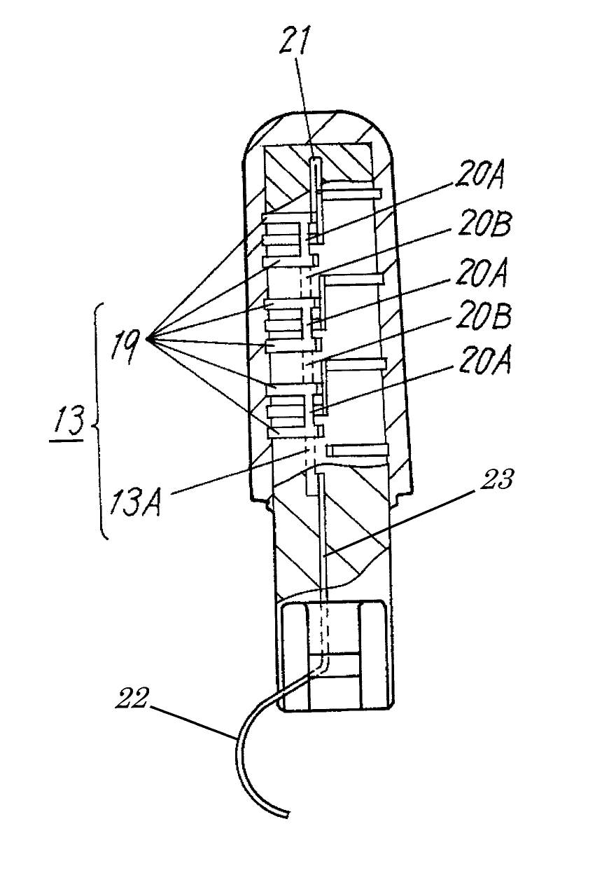

FIGS. 7 and 8 are cross-sectional views seen from the front and from the right hand side of the antenna, respectively, in accordance with a second preferred embodiment. In the figures, like parts are identified by the same references as in the structure of the first embodiment and the detail explanation will be omitted. As shown in FIGS. 7 and 8, helical-shaped portion 12 and meander-shaped portion 13 of antenna element 11 are formed of, like the structure described in the first embodiment (see FIG. 1), a thin metal plate with superior conductivity including a copper alloy plate, through die-cutting and press processes. Portion 12 and portion 13 are connected with each other at joint portion 21 adjacent to the top end of core rod 24. In the embodiment, as shown in FIG. 7, antenna element 11 is formed in one-piece with feed terminal 23 linked to bottom end 13A of meander-shaped portion 13. Feed terminal 23 contains elastic metal-plate contact 22, which is firmly connected to the input/output circuit pattern of the radio-frequency circuit in a radio communication apparatus when the antenna is fixed to the apparatus (see FIG. 8). Terminal 23, as shown in FIG. 7, has intimate contact with core rod 24. ABS resin-made rod 24, which has a dielectric constant of about 2.3, contains flexible pawl 25 at the perimeter of the bottom end of rod 24. Pawl 25 is used for snap-in fitting the antenna into the radio communication apparatus. Radome 16 shields the periphery of antenna element 11, with the lowermost part of rod 24 and contact 22 being exposed.

According to the embodiment, in addition to the advantages in the structure in the first embodiment, antenna element 11 and feed terminal 23 are formed into one-piece. The integrated structure contributes to a reduced parts count, realizing a cost-reduced antenna.

Third Preferred Embodiment

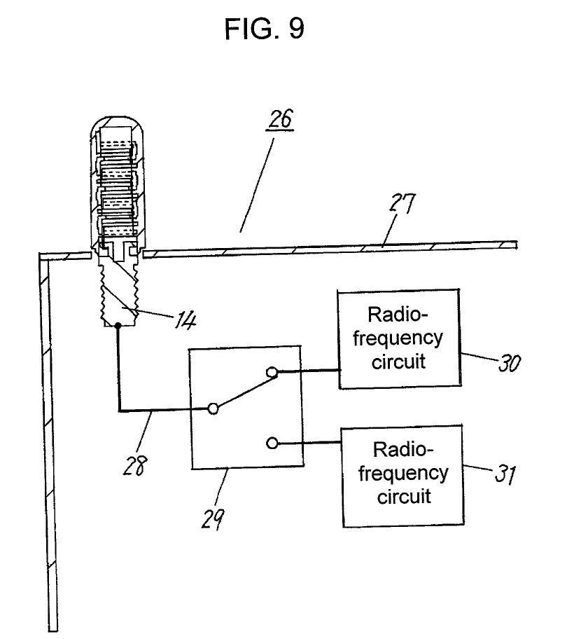

FIG. 9 is a circuit diagram of a radio communication apparatus equipped with the antenna in the third preferred embodiment. For the same construction as those described in the first through the fourth preferred embodiments, like parts are identified by the same references and the detail explanation will be omitted. The radio communication apparatus is, as shown in FIG. 9, designated by the numeral 26. An antenna (see FIGS. 1 and 2) is fixed with insulating resin-made housing 27 of radio communication apparatus 26. In apparatus 26, feeder 28 connects metal fitting 14 of the antenna to switch 29, through which fitting 14 is connected to radio-frequency circuit 30 for the first frequency band and to radio-frequency circuit 31 for the second frequency band.

According to the embodiment, the antenna can be easily attached to apparatus 26. In addition, the antenna has impedance characteristics suitable for desired multi-ranged frequency bands, which does away with the need to add a complicated impedance-matching circuit to the radio-frequency circuit in apparatus 26. This fact realizes a low-cost antenna.

Fourth Preferred Embodiment

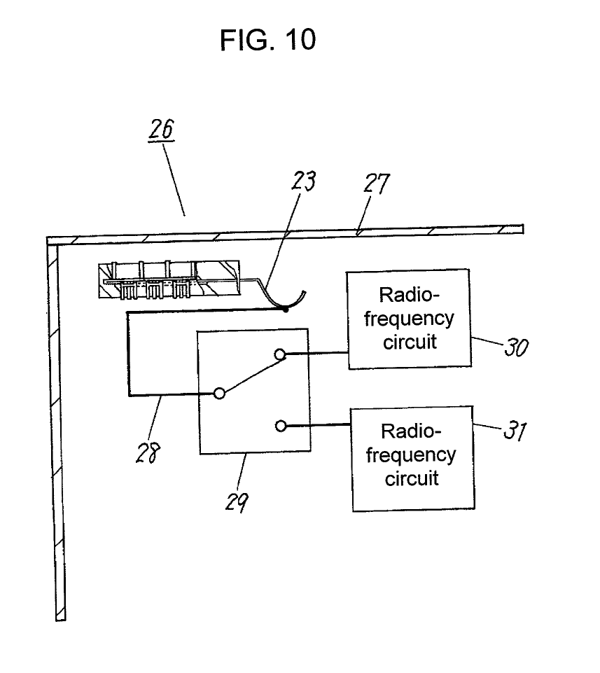

FIG. 10 is a circuit diagram of a radio communication apparatus equipped with the antenna in the fourth preferred embodiment. For the same construction as those shown in the seventh and eighth preferred embodiments, like parts are identified by the same references and the detail explanation will be omitted. The antenna—the one shown in FIG. 7, with radome 16 removed—is fixed onto a circuit board (not shown) in housing 27 of radio communication apparatus 26, as shown in FIG. 10. In apparatus 26, feeder 28 connects feed terminal 23 of the antenna to switch 29, through which the antenna is connected to radio-frequency circuit 30 for the first frequency band and to radio-frequency circuit 31 for the second frequency band.

According to the embodiment, in addition to the advantages in the structure in the first through the third embodiments, the antenna built into the radio communication apparatus can protect itself from getting damaged when apparatus 26 is accidentally dropped or given physical shock. It is possible to provide not only smaller-sized apparatus 26, but also easy installation of the antenna to the apparatus. As a result, the manufacturing cost of apparatus 26 can be substantially reduced.

Fifth Preferred Embodiment

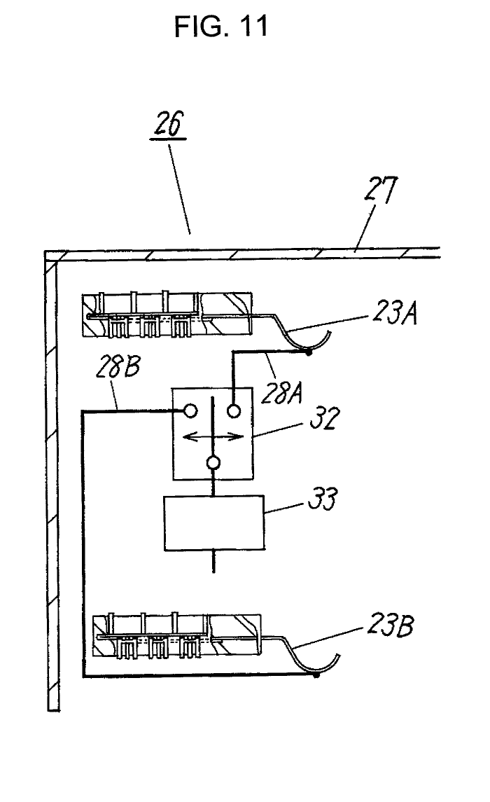

FIG. 11 is a circuit diagram of a radio communication apparatus equipped with the antenna in the fifth preferred embodiment. For the same construction as those shown in the seventh and the eighth preferred embodiments, like parts are identified by the same references and the detail explanation will be omitted. A first antenna and a second antenna—both are the same as the antenna shown in FIG. 7, with radome 16 removed—are disposed, as shown in FIG. 11, at the upper and the lower portions of a circuit board (not shown) in housing 27 of apparatus 26, respectively. Feeders 28A, 28B connect feed terminals 23A, 23B of the first and the second antennas to switch 32, respectively. The switching terminal is connected to radio-frequency circuit 33. A circuit following circuitry 33 compares the receiving signal power level of the first antenna with that of the second one, by which circuitry 33 is automatically switched by switch 32 to the antenna having receiving signal power greater than the other. It becomes thus possible to perform diversity communication.

According to the embodiment, in addition to the advantages demonstrated in the fourth preferred embodiment, multiple use of antennas with impedance characteristics equivalent to each other in a desired frequency band can eliminate variations in impedance characteristics. This provides not only a diversity communication system in a radio communication apparatus with high antenna gain and reliability, but also a cost-reduced radio communication apparatus due to the simple installation of the antenna to the apparatus.

### INDUSTRIAL APPLICABILITY

According to the embodiment, as described above, the antenna element formed of the combination of the helical-shaped portion and the meander-shaped portion can easily adjust each electric length for the two portions. It is therefore possible to obtain good impedance characteristics in desired multi-ranged frequency bands, realizing a smaller and cheaper antenna having wide frequency range, high antenna gain and reliability. Using the antenna allows the installation of the antenna to a radio communication apparatus to be simple. As additional plus, the antenna has good impedance characteristics for desired multi-ranged frequency bands, which does away with the need to add a complicated impedance-matching circuit to the radio-frequency circuit, realizing a low-cost antenna.

What is claimed is:

1. An antenna transmitting/receiving waves in a plurality of frequency bands comprising:
a conductive antenna an element portion;
a feed portion establishing electrical connections between the antenna element portion and a radio-frequency circuit of a radio communication apparatus;
a dielectric material-made core rod mechanically supporting the antenna element portion; and
a dielectric material-made radome partially covering the antenna element portion and the feed portion,
wherein the antenna element portion includes an approximately helical-shaped portion concentric to the core rod and an approximately meander-shaped portion.

2. The antenna of claim 1, wherein a dielectric material forming the core rod is provided with a relative dielectric constant different from a dielectric material forming the radome.

3. The antenna of claim 1, wherein a half-round and thin-belt-shaped first conductor whose diameter is generally identical with a diameter of the core rod is disposed in parallel from a position close to an end of the core rod in axial direction threreof, at a predetermined spaced interval, taking a form of a staggered arrangement between a front-round surface and a rear-round surface of the core rod, adjacent ends of the first conductor are connected with a short and thin- belt-shaped conductor to form the approximately helical-shaped portion, a thin belt-shaped second conductor is further placed in parallel and adjacent ends of the conductor are connected with another short and thin-belt-shaped conductor to form an approximately meander-shaped portion, the meander-shaped portion is disposed adjacent to the approximately helical-shaped portion.

4. The antenna of claim 3, wherein the first and the second conductors are made of a die cutting-processed thin and conductive metal-plate.

5. The antenna of claim 3, wherein the antenna element portion is formed of a press-processed conductive metal-wire made of a copper alloy, or another metal provided with an electrolytic plating process.

6. The antenna of claim 3, wherein the antenna element portion is formed of press-procesed thin conductive plate with a predetermined pattern provided by etching process.

7. The antenna of claim 3, wherein the antenna element portion is formed of a press-processed flexible wiring board with a predetermined pattern formed thereon.

8. The antenna of claim 3, wherein the antenna element portion is formed by printing conductive paste.

9. The antenna of claim 3, wherein the antenna element portion is formed of sintered conductive powder.

10. The antenna of claim 3, wherein one end of the approximately helical-shaped portion is joined with one end of the approximately meander-shaped portion so that the helical-shaped portion and the meander-shaped portion are disposed on the rod as a cascaded structure.

11. The antenna of claim 3, wherein a position close to a tip of the core rod has a connecting point, at which one end of the approximately helical-shaped portion and the approximately meander-shaped portion are connected, the approximately meander-portion is disposed in parallel to an axis of the helical-shaped portion, being “folded over” at the connecting point.

12. The antenna of claim 3, wherein a position close to a tip of the core rod has a connecting point, at which one end of the approximately helical-shaped portion and the approximately meander-shaped portion are connected, at least a part of the second conductor is shaped in an arc, with a diameter substantially identical with that of the helical-shaped portion, the meander-shaped portion is disposed so as to be “folded over” at the connecting point, having no contact with, and being concentric to the helical-shaped portion.

13. The antenna of claim 3, wherein the feed portion is formed with the antenna element portion in one piece.

14. A radio communication apparatus equipped with the antenna of claim 1 capable of communicating in the plurality of frequency bands.

15. An antenna transmitting/receiving waves in a plurality of frequency bands comprising:
a conductive antenna element portion;
a feed portion establishing an electrical connection between the antenna element portion and a radio-frequency circuit of a radio communication apparatus; and
a dielectric material-made core rod mechanically supporting the antenna element portion,
wherein the antenna element portion further includes an approximately helical-shaped portion concentric to the core rod and an approximately meander-shaped portion.

16. The antenna of claim 15, wherein a half-round and thin-belt-shaped first conductor whose diameter is generally identical with a diameter of the core rod is disposed in parallel from a position close to an end of the core rod in axial direction thereof, at a predetermined spaced interval, taking a form of a staggered arrangement between a front-round surface and a rear-round surface of the core rod, adjacent ends of the first conductor are connected with a short and thin-belt-shaped conductor to form the approximately helical-shaped portion, a thin belt-shaped second conductor is further placed in parallel and adjacent ends of the conductor are connected with another short and thin-belt-shaped conductor to form an approximately meander-shaped portion, the meander-shaped portion is disposed adjacent to the approximately helical-shaped portion.

17. The antenna of claim 15, wherein the first and the second conductors are made of a die cutting-processed thin and conductive metal-plate.

18. The antenna of claim 15, wherein the antenna element portion is formed of a press-processed conductive metal-wire made of a copper alloy, or another metal provided with an electrolytic plating process.

19. The antenna of claim 15, wherein the antenna element portion is formed of press-processed thin conductive plate with a predetermined pattern provided by etching process.

20. The antenna of claim 15, wherein the antenna element portion is formed of a press-processed flexible wiring board with a predetermined pattern formed thereon.

21. The antenna of claim 15, wherein the antenna element portion is formed by printing conductive paste.

22. The antenna of claim 15, wherein the antenna element portion is formed of sintered conductive powder.

23. The antenna of claim 15, wherein one end of the approximately helical-shaped portion is joined with one end of the approximately meander-shaped portion so that the helical-shaped portion and the meander-shaped portion are disposed on the rod as a cascaded structure.

24. The antenna of claim 15, wherein a position close to a tip of the core rod has a connecting point, at which one end of the approximately helical-shaped portion and the approximately meander-shaped portion are connected, the approximately meander-portion is disposed in parallel to an axis of the helical-shaped portion, being “folded over” at the connecting point.

25. The antenna of claim 15, wherein a position close to a tip of the core rod has a connecting point, at which one end of the approximately helical-shaped portion and the approximately meander-shaped portion are connected, at least a part of each second conductor is shaped in an arc, with a diameter substantially identical with that of the helical-shaped portion, the meander-shaped portion is disposed so as to be “folded over” at the connecting point, having no contact with, and being concentric to the helical-shaped portion.

26. The antenna of claim 15, wherein the feed portion is formed with the antenna element portion in one piece.

27. A radio communication apparatus equipped with the antenna of claim 15 capable of communicating in a plurality of frequency bands.

28. A radio communication apparatus for diversity communication, not only equipped with each of antennas of claim 1 or claim 15, or a plurality of combinations of the antennas of claim 1 and the antennas of claim 15, but also provided with a switch to perform a predetermined switching between the antennas.
